(19) United States
(12) Patent Application Publication
(10) Pub. No.: US 2007/0162653 A1
(43) Pub. Date: Jul. 12, 2007

(54) DATA TRANSFER DEVICE AND METHOD OF TRANSMITTING DATA

(75) Inventors: Marcus Janke, Munich (DE); Peter Laackmann, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/608,479

(22) Filed: Dec. 8, 2006

(30) Foreign Application Priority Data
Dec. 9, 2005 (DE) 102005058878.6-31

(51) Int. Cl. G06F 13/00

(52) U.S. Cl. 710/34

(57) ABSTRACT

A data transfer device having a data input and a data output has a data transmitter for transmitting data at the data input to the data output. The data transfer device includes a counter for decrementing/incrementing a counter value for each data passing the data output. The data transfer device also includes a monitor for monitoring the counter value and for outputting an alarm signal if the predetermined condition is met.

### CROSS-REFERENCE TO RELATED APPLICATION

This application claims priority from German Patent Application No. 10 2005 058 878.6, which was filed on Dec. 9, 2005, and is incorporated herein by reference in its entirety.

### FIELD OF THE INVENTION

The present invention relates to a data transfer device, in particular to a UART (universal asynchronous receiver/transmitter) as may be employed, for example, in chip cards or in smart cards.

### BACKGROUND

Already in relatively simple microcontroller circuits, use is made of transmit and receive units for receiving and transferring data to circuit elements connected externally to the microcontroller and other components. Since the transmit and receive units lighten the load on a central processing unit (CPU), typically a microcontroller because the transmit and receive unit provides data supplied by the CPU, with, inter alia, synchronization information and processes them on a signal level, and transfers them. If a respective transmit and receive unit were not among the elements implemented on the microcontroller and/or on a chip comprising the respective microcontroller, the CPU would have to also take over the tasks of the transmit and receive unit. Because of this, the efficiency of the microcontroller would be considerably reduced, since the latter cannot perform any further operations during the time when data is transmitted.

For this reason, current microcontrollers exhibit respective transmit and receive units which are among the elements implemented on the chip. Frequently, respective transmit and receive units are referred to as UART (universal asynchronous receiver/transmitter). UARTs are frequently coupled directly to a bus of a microcontroller, to which typically a CPU and a memory are also connected. Since communication between the microcontroller and an external component, for example a chip-card reading device, is very often performed in a serial manner, in particular in the field of chip cards and/or smart cards, it is the task of the UART to supplement the data which mostly comes in on the bus of the microcontroller—the bus being mostly configured as a parallel bus—with synchronization information and checksums, inter alia, and subsequently to provide this data at a respective terminal in the form of serial signals.

Since currently, chip cards are frequently used especially in the field of security monitoring, for example in controlling access to areas which are not accessible to the public, to computer systems, and also for storing confidential data, for example for storing private keys within the framework of a public-key method, such chip cards, or the microcontrollers integrated thereon, which are also referred to as security controllers, are frequently subject to attacks. An attack on security controllers which is frequently used consists in that an attempt is made, by means of a method referred to as error induction, to have more data output from the chip of the security controller, during an output operation, than was actually envisaged and/or intended by the programmer of the security controller. For example, in the present example, after the security controller has been reset, it is to output a byte sequence referred to as ATR (answer to reset) having a length of 16 bytes. If the security controller is disturbed, in this phase, by an attacker in such a manner that further bytes are output until, e.g., a total of 256 bytes have been output although not scheduled, there is the possibility that secret information may be contained within the bytes additionally output.

Various possibilities have been known and described of detecting the origin of such a fault attack, for example by using sensors within the security controller, or, of preventing or detecting the coming into being of such a respective error within an area referred to as the core of the chip, which includes, e.g., the CPU, the memory, as well as any cryptoprocessors and (pseudo) random number generators that may be present. However, all of these approaches have the disadvantage that they are relatively expensive. For example, they generally require a high level of development work and are frequently very expensive in regard to the realization of the final product.

### SUMMARY OF THE INVENTION

A data transfer device having a data input and a data output has a data transmitter for transmitting data at the data input to the data output. The data transfer device includes a counter for decrementing/incrementing a counter value for each data passing the data output. The data transfer device also includes a monitor for monitoring the counter value and for outputting an alarm signal if the predetermined condition is met.

### BRIEF DESCRIPTION OF THE DRAWINGS

These and other objects and features of the present invention will become clear from the following description taken in conjunction with the accompanying drawing, in which:

FIG. 1 is a block diagram of an embodiment of a security controller comprising a data transfer device; and

FIG. 2 is a block diagram of another embodiment of a security controller comprising a data transfer device.

### DESCRIPTION OF PREFERRED EMBODIMENTS

The present invention is based in part on the findings that to improve the security of a security controller attacks on an output function of the security controller are blocked by expanding a data transfer device such that it will restrict the transmission of data via a data output of the data transfer device by decrementing or incrementing a count value of a counter, and by comparing the count value with a comparison value.

An exemplary embodiment of the inventive data transfer device includes a data transmit or transmitter means for transmitting data, which comes in at a data input of the data transfer device, via a data output, a counter for decrementing/incrementing a counter value for each data passing the data output, and a monitoring means for monitoring the counter value in terms of whether it meets a predetermined condition, and, if this is so, for outputting an alarm signal.

In an embodiment of the inventive method of transmitting data, which comes in at a data input, via a data output, a data is transmitted via the data output, a counter value is incremented or decremented, monitoring is performed as to whether the counter value meets a predetermined condition, an if the counter value meets the predetermined condition, an alarm signal will be output.

The data transfer device and of the method of transmitting data, coming in at a data input, via a data output is that is implemented in a simple manner and at very low cost, so that attacks on the output function, so-called dumps, may be blocked, in particular, for relatively low-cost security controllers. The expense in terms of construction and development technology may be clearly reduced. In many embodiments, only a minor adaptation of the programming of the security controller is necessary in addition to introducing a data transfer means modified in accordance with the invention, as will be explained in the further course of the application.

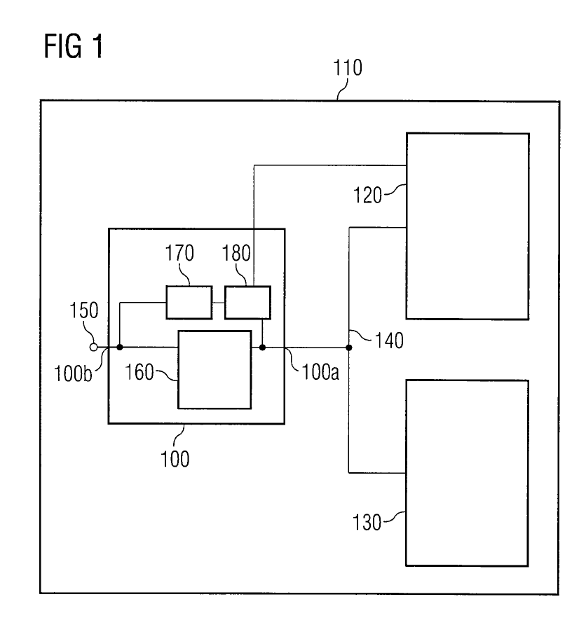

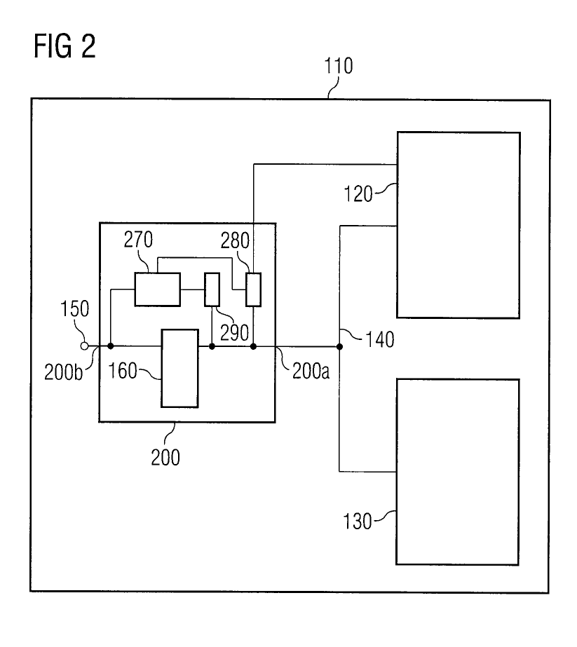

With reference to FIGS. 1 and 2, an embodiment of a security controller comprising data transfer device will be described below. Identical or similar reference numerals will be used in FIGS. 1 and 2 for identical or similar objects.

The embodiments shown in FIGS. 1 and 2 are based on two different approaches to monitoring a number of data transmitted. While in the embodiment shown in FIG. 1, is based on a starting value, for example 0, the number of data transmitted is determined by incrementing a counter, and is compared with a comparison value and/or target value, and/or is monitored and/or verified by a comparison means and/or monitoring means. In the embodiment shown in FIG. 2, the counter is initialized with a starting value and is decremented with each data passing a data output. The comparison means and/or monitoring means in this case will output the alarm signal once the comparison value and/or the target value, in the present embodiment the value of 0, is reached. However, in principle it is not necessary to transfer/convey the count value of the counter to the comparison means and/or monitoring means. For example, it is also quite feasible for the alarm signal to be output when a predetermined condition is met, i.e. for example the “overflowing” or “underflowing” of the counter value, which may be indicated, for example, by setting a carry flag as an overflow/underflow signal. Alternatively, it is also possible to verify only a value having been reached, for example, by monitoring and/or verifying the setting of a zero flag indicating a counter value of 0. Generally speaking, meeting the predetermined condition may thus correspond, for example, to the counter value and/or count value being reached, exceeded or fallen below by a target value, but may also correspond to meeting a predetermined relation between the counter value and the comparison value or the target value.

FIG. 1 shows a block diagram of an embodiment of a data transfer device 100 comprising a security controller 110 in addition to a CPU 120 (CPU=central processing unit), a memory 130 and a bus 140. Bus 140 connects CPU 120 and memory 130. In addition, data transfer device 100 is also coupled to bus 140 via a data input 100a. Bus 140 may be embodied, in principle, as any data bus. Typically, bus 140 is designed for parallel or serial data transmission, a parallel data transmission being implemented with preference since it generally enables a higher data transfer rate.

In addition to data input 100a, data transfer device 100 also comprises a data output 100b connected to an external terminal 150. External terminal 150 may be configured as a terminal pin or as a contact pad of a chip into which the controller, or security controller 110, is integrated, in the event of a contact communication with an external circuit not shown in FIG. 1. In the event of a contactless communication with an external circuit, external terminal 150 is frequently coupled to an inductance (e.g. a coil or one or several windings of an antenna coil or another inductance), a capacitance, a resonant circuit, an antenna, or another device for communicating by means of radio waves.

Data is typically transmitted, or sent, via data output 100b of data transfer device 100 using a serial transfer protocol. The data at data input 100a of data transfer device 100, is typically transferred using a parallel data transfer protocol. Data transfer device 100 is frequently referred to as a universal asynchronous receiver/transmitter (“UART”).

Data transfer device 100, or UART 100, comprises a data transmit means 160 having a first terminal coupled to data input 100a, and having a second terminal coupled to data output 100b, a counter 170, and a monitoring means or monitor 180, or comparison means or comparator 180. Counter 170 is also coupled to data output 100b via a first terminal, and is coupled to comparison means 180 via a second terminal. In addition to a first terminal with which it is coupled to counter 170, comparison means 180 comprises a second terminal via which it is coupled to CPU 120.

Under normal operating conditions and when security controller 110 is not communicating with an external circuit not depicted in FIG. 1, i.e., in particular, is transmitting data to this external circuit not shown in FIG. 1, CPU 120 and memory 130 may exchange data with one another via bus 140. Communication of data from the security controller 110 to an external circuit is taken on, in principle, by UART 100. Data transmit means 160 here takes on both protocol conversion (parallel protocol to serial protocol), the actual output of the data as well as the signal matching necessary for this purpose. Data transmit means 160 thus receives the data in the parallel protocol of bus 140, processes it, and makes available, at its second terminal, a serial data stream processed accordingly.

UART 100 comprises a security circuit which may be implemented, in principle, into all existing security controllers, and whose central components are counter 170 and comparison means 180. As will be explained in detail below, this expansion of UART 100 allows, for example by coupling comparison means 180 to bus 140, to make available a comparison value to comparison means 180 prior to an intended transmission of data to an external circuit via external terminal 150. In other words, UART 100 may be programmed to a specific value prior to an envisaged output of data. Counter 170 detects the number of data transmitted via data output 100b, and by comparing the counter value of counter 170 with the comparison value which has been preset or has been made available to comparison means 180, the number of data output by UART 100, i.e. of the bytes output, may thus be detected and subsequently restricted. To this end, counter 170 is initialized to a predetermined starting value, i.e. is set to, e.g., a counter value of 0, by an announcement of an intended transmission of data. Here it is also possible to communicate the comparison value to comparison means 180 at the same time, so that the communication of the comparison value and the initialization may be performed simultaneously. The initialization and the communication of the comparison value, may also be performed at different times, for example by separate sequences of instructions by CPU 120. If data is made available to UART 100 at data input 100a, this data will be processed by data transmit means 160 and output at data output 100b.

Because counter 170 is coupled to data output 100b of UART 100, the counter value of counter 170 comprises the number of data transmitted since the latest initialization of counter 170. Since counter 170 makes available the counter value to comparison means 180, comparison means 180 can generate an alarm signal at the second terminal of comparison means 180 when the comparison value is exceeded by the counter value, the alarm signal in turn being made available to CPU 120. CPU 120 thus may be designed, for example, when the alarm signal arrives, such that the operation being performed at the moment of the arrival is cancelled. In addition, it is also possible for the entire security controller 110 in this case to be stopped by CPU 120, or for another protection mechanism implemented on the chip, which includes security controller 110, to be triggered. In other words, if an attempt is made to output more than the predefined number of bytes, the UART 100 may, depending on its configuration, stop the ongoing operation or send an alarm which may then stop the entire chip.

FIG. 2 shows a block diagram of another embodiment of an inventive security controller and/or of a security controller chip 110, which differs from the embodiment shown in FIG. 1 in terms of the structure of the data transfer device 200 and/or of the UART 200. The security controller 110 depicted in FIG. 2 also comprises a CPU 120, a memory 130, a bus 140 and an external terminal 150 which are wired in a manner which is identical to the embodiment of a security controller 110 which is depicted in FIG. 1. Just like UART 100 of FIG. 1, UART 200 comprises a data input 200a and a data output 200b. Just like data input 100a of UART 100, data input 200a of UART 200 is coupled to bus 140. In addition, data output 200b of UART 200 is also coupled to external terminal 150, as has already been shown by the embodiment of FIG. 1. Within UART 200, data input 200a is connected to a first terminal of a data transmit means 160, and data output 200b is connected to a second terminal of data transmit means 160, data transmit means 160 matching that shown in FIG. 1 in this regard, too.

In addition, UART 200 comprises a counter 270, a comparison means 280, and a provision means 290. Here, counter 270 is coupled to data output 200b via a first terminal, is coupled to comparison means 280 via a second terminal, and is coupled to a first terminal of provision means 290 via a third terminal. In addition, provision means 290 is coupled to data input 200a of UART 200 via a second terminal. In addition to a first terminal via which comparison means 280 is coupled to counter 270, comparison means 280 comprises a second terminal via which it is connected to CPU 120.

The mode of operation and the interaction of CPU 120, of memory 130 and of bus 140 do not differ from the embodiment of a security controller 110 which is shown in FIG. 1, so that for the description of the mode of operation, reference shall be made to the respective above paragraphs. Also, the mode of operation of data transmit means 160 of UART 200 does not differ from the mode of operation of data transmit means 160 of UART 100 of FIG. 1.

In order to block, in the embodiment shown in FIG. 2, an attack on the output function of security controller 110, i.e. a so-called dump, the number of bytes which are allowed to be output by security controller 200 is initially determined. In the embodiment shown in FIG. 2, the actual output is controlled at data output 200b of UART 200, which acts as an output module of security controller 110. Thus, UART 200 comprises, in turn, a control function for monitoring the amount of data actually transmitted at data output 200b. In the case of the UART 200 as is employed on security controller 110 depicted in FIG. 2, the output of the start/frame bits of the serial data stream of data transmit means 160 may be tapped and detected, for example, by counter 270, so that the start/frame bits of the serial data transmission protocol act upon counter 270, which eventually counts them.

In this case, the counter is decremented rather than incremented. To this end, following a determination of the number of the bytes to be transmitted, which may be performed, e.g., by CPU 120, the respective number is increased by 1, and is made available and/or communicated to provision means 290 as a starting value. Alternatively, the process of increasing the number of bytes to be transmitted by 1 may also be taken on by provision means 290. The determination of the number of bytes to be output may be part of the programming of security controller 110. This may be configured, for example, such that the programming of security controller 110 comprises one or several lines of instructions prior to each output, the line(s) of instruction communicating the number of data planned, or envisaged, to provision means 290, for example by writing into a specific register or address. Thereupon, provision means 290 initializes counter 270 with the starting value. Subsequently, counter 270 is reduced by 1 with each start/frame bit output at data output 200b by data transmit means 160. The respectively current counter value is now available to comparison means 280 via the connection between counter 270 and comparison means 280, or the monitoring means. If this counter value reaches a predetermined comparison value or a comparison value determined, for example, by CPU 120, i.e., for example, a value of 0, the comparison means will output, at its second terminal, an alarm signal which may be supplied, for example, to CPU 120, as is also shown by FIG. 2. As has already been explained in connection with the embodiment shown in FIG. 1, it is also possible, in the event that an attempt is made to output more than the predefined number of bytes, to cause the ongoing operation to stop, or to cause an alarm to be transmitted, so that the entire chip which includes security controller 110 may be stopped.

In the introductory sections of the present application, an interference with the security controller within the framework of security controller 110 being reset was already discussed as a possible attack scenario. As was already illustrated there, within the framework of a reset on the part of security controller 110, a sequence of bytes are output at external terminal 150, the byte sequence also being referred to as ART (answer to reset). Depending on the protocol used, the ART signal exhibits a certain length. If this length comprises, e.g., 16 bytes, the software within security controller 110 will be programmed such that counter 270 of UART 200 is set to an alarm value and/or comparison value or starting value of 17 by provision means 290. Subsequently, security controller 110 or, more specifically, CPU 120 will output the UART byte sequence, it being intended in the present example, according to the schedule, to output 16 bytes. If, during the subsequent output of the 16 bytes of the UART byte sequence, an attacker interferes with security controller 110, for example by means of light pulses, ion bombardment, targeted voltage surges accompanied by, or also by means of, other invasive measures, such as re-grinding or re-etching of certain areas of the chip which includes security controller 110, in such a manner that the program running on CPU 120 would output additional bytes, the control function implemented by counter 270, provision means 290 and comparison means 280 will intervene.

If an attacker succeeds in manipulating the output of security controller 110 and/or the output of CPU 120 in such a manner that more than the intended 16 bytes would be output, comparison means 280 triggers an alarm within the UART 200 in connection with counter 270, however, when the 17^{th} byte is arrived at, i.e. in the present case, when the comparison value 0 is arrived at by the count value, so that in the present embodiment, an alarm signal is supplied to CPU 120, so that CPU 120 will recognize the alarm, or the attack, and may take suitable counter measures, for example a renewed reset (security reset). In this case, the attack has failed.

Both the counters 170, 270 and the memory for the alarm value and/or comparison value may be configured in the form of an SFR (special function register). It is quite possible for the respective SFR to be arranged, in spatial terms, within the area of CPU 120. In addition, it is also possible to protect the SFR from invasive interventions. In one embodiment, the SFR is specially arranged within an area of the chip, including security controller 110, which comprises a high density of functional elements, for example transistors, capacitors or other devices which are indispensable for the functioning of security controller 110. In this manner, an invasive intervention in security controller 110 is made more difficult due to the fact that it is very likely for surrounding areas to be also damaged within the framework of an invasive intervention, so that the overall functioning of security controller 110 will no longer be ensured and/or that same will be destroyed in the intervention.

In the embodiments shown in FIGS. 1 and 2, data transmit means 160 is hardwired on security controller 110 and/or security controller chip 110, and is designed such that it processes accordingly, at its second terminal, each data provided at its first terminal, and thus at data input 100a, 200a of the UART 100, 200, and thus outputs it at data output 100b, 200b of the UART 100, 200. Thus, in the embodiments described here, it is configured to be non-programmable, and comprises no internal logic for monitoring the number, nature or content of the data transmitted although such functions are possible.

The embodiments shown in FIGS. 1 and 2 are based on the implicit assumption that counter 170, 270 has been incremented, or decremented, with a step size of 1, any step size is feasible here, in principle. For example, the step size may depend on the type of data to be transmitted, i.e. may also be adjustable and/or programmable by CPU 120. Typically, however, the step size for incrementing or decrementing the counter value of counter 170, 270 will be 1. In addition, both the counter value of counter 170, 270 and the comparison value may refer to a byte, a bit, a data word of CPU 120 and/or of memory 130, or to any other number of bits.

As has already been explained in connection with the embodiment shown in FIG. 1, the data transfer device 100, 200, or the UART 100, 200 for communicating with an external circuit may also be effected, in addition to a contact communication via an electrical contact of the chip and/or security controller chip 110 including the UART 100, 200, for example, in the form of a pin or a contact pad, by means of contactless communication. In this case, the external terminal 150 is not connected to a pin and/or a contact pad, but to a transmit device. If, for example, the communication is effected via radio waves, this transmit device may be, for example, an inductance, a capacitance, a resonant circuit, an antenna or even a more complex radio transmit device which may transmit data via, for example, amplitude modulation, frequency modulation or phase modulation in a coded manner. If, on the other hand, signal transmission is performed in an optical manner—an optical signal transmission being understood, within the framework of the present application, to also mean a signal transmission in the infrared range, in the microwave range and in the ultraviolet range, in addition to a signal transmission within the visible wavelength range—an LED (light emitting diode), a laser diode or a different light source may be employed for transmission.

Even though the preferred embodiments, shown in FIGS. 1 and 2, of a security controller 110 have included only CPU 120, memory 130, bus 140 and data transfer devices 100, 200, an appropriate security controller 110 may readily comprise further components. These further components include, e.g., cryptoprocessors, (pseudo) random number generators, sensors for electrical, mechanical, chemical or other quantities, other components for specific tasks (special components) as well as further terminals and data transfer devices for communicating with external circuits, in particular receive means.

In another embodiment, a realization of counter 170, 270 and of comparison means 180, 280 is also feasible, wherein the comparison value of comparison means 180, 280 and the starting value of counter 170, 270 comprise values which are predetermined or may be influenced and which deviate from the values mentioned. Thus, it is quite feasible that, for example, counter 170, 270 is initialized with a starting value of 40, that the counter is incremented by 8 with each byte passing data output 100b, 200b, and that comparison means 180, 280 outputs an alarm signal at a comparison value of 64.

In addition, it is also feasible, that a fixed, predetermined comparison value is employed within the framework of UART 100, 200, i.e. that the comparison value may not be changed, for example, by respectively programming CPU 120. Accordingly, it is also feasible that a fixed, predetermined starting value is employed, i.e. that the starting value may not be changed, for example, by CPU 120. This results in the possibility of improving the security of security controller 110 against attacks with only one comparatively simple and limited change in the layout by introducing a UART 100, 200 modified in accordance with the invention. Such an “upgrade”, i.e. replacing a conventional UART by a modified, UART 100, 200 is, in principle, feasible in all security controllers and may be implemented at low cost, so that even for low-cost, low-end security controllers 110, the level of security can be fundamentally increased by means of an inventive data transfer means.

Depending on the circumstances, the method of transmitting data, which comes in at a data input, via a data output may be implemented in hardware or in software. The implementation may be effected on a digital storage medium, in particular a disk, an electronic memory, a CD, or a DVD comprising electronically readable control signals which may cooperate with a programmable computer system such that the respective method is performed. Thus, one embodiment of the invention generally consists of a computer program product having a program code, stored on a machine-readable carrier, for performing the method, when the computer program product runs on a computer. In other words, the method and system may be realized as a computer program having a program code for performing the method, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A data transfer device having a data input and a data output comprising:
a data transmitter for transmitting data at the data input to the data output;
a counter for decrementing/incrementing a counter value for each data passing the data output; and
a monitor for monitoring the counter value and for outputting an alarm signal if a predetermined condition is met.

2. The data transfer device as claimed in claim 1, wherein the predetermined condition further comprises a target value being reached, exceeded or fallen below.

3. The data transfer device of claim 1, further comprising a provider for providing a comparison value as a target value.

4. The data transfer device of claim 1, wherein the data transfer device is a UART (universal asynchronous receiver/transmitter) connected to a CPU (central processing unit) via a data bus.

5. The data transfer device of claim 4, wherein the predetermined condition is adjustable by software running on the CPU.

6. The data transfer device of claim 1, wherein the data transfer device is implemented on a security controller chip and adapted to transmit data to an off-chip component.

7. The data transfer device of in claim 1, wherein the counter decrements the counter value by a fixed value for each data passing the data output.

8. The data transfer device as claimed in claim 7, wherein the counter is initialized with a starting value not equal to 0, and the monitor is configured to output the alarm signal when the count value is 0.

9. The data transfer device of claim 1, wherein the counter is configured to perform the decrementation/incrementation for each byte passing the data output or for each sequence of a predetermined number of bytes or bits.

10. The data transfer device of claim 1, wherein the data transmitter is hardwired and configured to transmit the data at the data input of the data transfer device at any rate.

11. The data transfer device of claim 1, wherein the monitor outputs an overflow/underflow signal as the alarm signal when the counter value underflows or overflows.

12. A method of transmitting data, which comes in at a data input, via a data output, comprising:
transmitting data via the data output;
incrementing or decrementing a counter value based on the transmitted data;
comparing the counter value to a predetermined condition; and
outputting an alarm signal when the counter value meets the predetermined condition.

13. A computer program stored as a computer readable media having a program code for performing a method of transmitting data, which comes in at a data input, via a data output, the method comprising:
transmitting data via the data output;
incrementing or decrementing a counter value based on the transmitted data;
comparing the counter value to a predetermined condition; and
outputting an alarm signal when the counter value meets the predetermined condition.

14. A data transfer device having a data input and a data output comprising:
data transmitter means for transmitting data at the data input of the data transfer device to the data output the data transfer device;
counter means for decrementing/incrementing a counter value based on the data passing the data output; and
a comparator for comparing the counter value to a predetermined condition and outputting an alarm signal if a predetermined condition is met.

15. The data transfer device of claim 14, wherein the predetermined condition comprises a target value being reached, exceeded, or fallen below.

16. The data transfer device of claim 14, further comprising provider means for providing a comparison value as the predetermined condition.

17. The data transfer device of claim 14, wherein the data transfer device is a UART (universal asynchronous receiver/transmitter) connected to a CPU (central processing unit) via a data bus.

18. The data transfer device of claim 17, wherein the predetermined condition is adjustable by software running on the CPU.
